(19) United States
(12) Patent Application Publication
(10) Pub. No.: US 2026/0241511 A1
(43) Pub. Date: Aug. 20, 2026

(54) METHOD FOR PRODUCING A MOUNT FOR MACHINE TOOLS AND CORRESPONDING MOUNTING SYSTEM

(71) Applicant: Heinrich Georg GmbH Maschinenfabrik, Kreuztal (DE)

(72) Inventor: Matthias Wittrock, Siegen (DE)

(21) Appl. No.: 19/082,508

(22) Filed: Mar. 18, 2025

(30) Foreign Application Priority Data
Feb. 19, 2025 (EP) 25158875.2

(51) Int. Cl. B24B 41/00; B24B 5/37; B24B 41/02; E04G 11/48

(52) U.S. Cl. CPC B24B 41/007; B24B 5/37; B24B 41/02; E04G 11/48

(57) ABSTRACT

A mounting system and method for producing a mount for machine tools, where the machine tool, such as a roll grinding machine, is supported in a displaceable manner on a machine bed, and the machine bed is in turn supported on a machine foundation standing on an installation floor at an installation site, and where adjustable fixators are interpositioned between the machine foundation and the machine bed, where the machine foundation is cast at the installation site on the installation floor in a casting mold provided at the installation site.

### BACKGROUND AND FIELD OF THE INVENTION

The invention relates to a method for producing a mount for machine tools and to a corresponding mounting system.

Machine tools require a mount which is as vibration-isolated and rigid as possible. For this purpose, it is possible to use a foundation block produced from concrete which is placed onto the workshop floor or is inserted into a corresponding pit in the workshop floor and is decoupled from the workshop floor by means of suitable damping elements. The machine bed is fastened onto the foundation block with interpositioning of adjustable fixators. However, this type of machine installation requires a relatively high level of manufacturing and assembly outlay and is associated with correspondingly high costs. For instance, the foundation block must be produced separately and transported to the usage site and, if necessary, must be raised accordingly on the damping elements for adjustment purposes.

Alternatively, a foundation block can be dispensed with and a hollow machine bed can be cast with concrete and placed onto the workshop floor over suitable damping elements.

### SUMMARY OF THE INVENTION

The present invention simplifies the installation and commissioning of machine tools and permits the same in a more cost-effective manner, as well as does so in a more environmentally friendly manner.

In accordance with the invention, it has been recognized that if, in order to produce a mount for machine tools, where the machine tool, in particular a roll grinding machine, is supported in a displaceable manner on a machine bed, the machine bed is, in turn, supported on a machine foundation standing on the installation floor with interpositioning of adjustable fixators at the installation site, the machine foundation is cast at the installation site on the installation floor in a casting mold provided at the installation site, it is possible to reduce the outlay for transport and handling.

Previous solutions, in particular for large machines, involve significant transport outlay and correspondingly high costs. This is obviated by the production at the final installation site. In addition, during on-site casting, a self-levelling effect of the casting material can assist with the adjustment of the machine foundation to the exact conditions, which facilitates assembly and precise orientation. In other words, the machine foundation for supporting the machine bed and the machine tool is cast locally at the site where it will be subsequently used. If necessary, this can also be effected without the need for complex excavation work.

The casting mold can be installed on a plurality of arranged and oriented vibration-damping and height-adjustable supporting elements. This eliminates the necessity to have to move the machine foundation again after production. The support elements typically consist of a lower soft damping material lying on the installation floor, and of an adjustable wedge shoe, which is fastened thereto, for height adjustment. On the one hand, this can prevent the transmission of vibrations to the machine tool and, on the other hand, can also compensate for unevenness in the installation floor. Alternatively, a full-surface soft support mat of appropriate thickness and corresponding to the footprint of the machine foundation could also be used. In order to achieve the same vibration damping properties, said support mat should be softer than the damping material of the support elements. The thickness is selected in such a way that it likewise meets the compensation requirement.

The casting mold used can be modular and/or can consist of a plurality of part-casting molds which are fixed to one another prior to the casting procedure.

For instance, the casting mold can consist e.g. of a plurality of trough-like part-casting molds which are connected on site in order to form the entire machine foundation. The part-casting molds can have mutually corresponding openings on the abutting sides for the flow of the casting material.

If the casting mold is modular, the casting mold can be composed of modules in order to provide the desired machine foundation mold for casting. For instance, modules can comprise e.g. cuboidal base elements which are combined with and connected to one another to form the final mold.

In general, the casting mold or part-casting molds can be at least partially removed after casting in order to be reused. This does not apply to the base element.

The casting mold or part-casting molds can also remain on the finished machine foundation or can become part thereof. For instance, the casting mold can be created e.g. with finished concrete elements which become part of the machine foundation by the casting process. It is feasible e.g. to use L-shaped blocks consisting of concrete which, being fixed next to one another, form side walls and floor regions of the casting mold. The same is also feasible with concrete blocks which become part of the machine foundation by the casting process.

The casting mold and part-casting molds can be designed as a construction kit which comprises a plurality of side wall panels or side wall shuttering boards, which can be fixed to one another temporarily for the casting procedure, and at least one lost base element which can be connected to the side wall panels or shuttering boards which are assembled at the installation site to form the casting mold or the part-casting molds. Sheet metal or concrete elements for producing the side walls of the casting mold can thus be arranged next to one another on the base element and can be fastened to one another and to the base element. Plug-in connections can also be used in order to connect the elements of the construction kit to one another. The side wall panels can be plug-connected to one another using a tongue and groove principle and can be inserted into corresponding slots in the base element via plug-in lugs. This allows simple, space-saving transport and extensive reuse, as well as tailoring of the casting mold or adaptability to suit different machine foundation sizes and shapes.

The base element can also consist of a plurality of mutually connectable part-elements. For instance, e.g. the base element can be a base plate which is constructed in a similar manner to the side wall panels. It is also feasible to use thin concrete slabs which are connected to one another.

The casting mold can be stabilized by supports during casting. The side wall panels can thus be held via supports during casting. The supports can be placed against each side wall panel or can be temporarily fixed to existing fastening points at that location. The supports can each have a vertical element for abutment against the panel and an oblique element for introducing the supporting force, which is connected to the vertical element.

For reinforcement, the aforementioned elements of the casting mold can be configured with ribs, beads, corrugations, Z-shaped cross-sections or be formed as sheet pile walls, etc. This also relates to the base element(s) as a whole or in part-regions.

Prior to the casting procedure, at least one reinforcement and/or a plurality of place holders for the adjustable fixators and/or ductwork for subsequent lines and/or media can be positioned in the casting mold.

The reinforcement can comprise a steel mesh. This can also consist of individual modules which overlap after being arranged. The place holders can be pot-shaped and are dictated by the subsequent accommodation of the anchors of the fixators to be used. Ductwork or media can also be introduced into the casting mold prior to the casting procedure to simplify subsequent installation and/or connection of the machine tool. The ductwork or media can be inserted after the reinforcement or, if necessary, can also be inserted as part thereof in modular form and can be connected to one another where necessary.

A concrete, in particular of class C40 or C45, is used for casting the machine foundation. Instead of the typical C20 or C25 concrete, this has a higher modulus of elasticity, so that the same rigidity can be achieved with smaller cross-sections, which is advantageous for the on-site casting procedure. In particular, this is because the conditions are not as controlled in this case as they are for prefabrication in the factory.

Polymer concrete or fibre-reinforced concrete can also be used. They have even higher moduli of elasticity, so that—depending on requirements—the cross-sections can be further adapted.

Prestressed concrete can likewise be used, wherein the prestressed anchors can be integrated into the casting mold. Preferably, the prestressing is effected in the longitudinal direction of the casting mold or the subsequent machine foundation.

After the casting has hardened, the fixators are fixed into the gaps, which are produced by the place holders, with grouting mortar after exact positioning. The fixators are used for precise orientation and arrangement of the machine bed. Therefore, they should also be precisely and accurately oriented and arranged in the place holders. Therefore, it is expedient to perform the precise orientation and arrangement by means of measuring devices. The anchors protruding into the place holders are then cast using casting mortar and are definitively fixed.

The invention also includes a correspondingly produced mounting system for supporting machine tools, wherein the machine tool, in particular a roll grinding machine, is supported in a displaceable manner on a machine bed, the machine bed is, in turn, supported on a machine foundation standing on the installation floor with interpositioning of adjustable fixators at the installation site, wherein the machine foundation has been cast locally at the installation site on the installation floor, as described above.

### BRIEF DESCRIPTION OF THE DRAWINGS

FIG. 1 shows a schematic perspective view of a roll grinding machine;

FIG. 2 shows a schematic perspective view of an installation floor during placement of supporting elements on the installation floor;

FIG. 3 shows a schematic perspective view of an installation floor during placement of a first part-casting mold on the supporting elements on the installation floor;

FIG. 4 shows a schematic perspective view of an installation floor during placement of a second part-casting mold on the supporting elements on the installation floor;

FIG. 5 shows a schematic perspective view of an installation floor during arrangement of a reinforcement in the casting mold formed from the two part-casting molds;

FIG. 6 shows a schematic perspective view of a machine foundation after casting of the casting mold;

FIG. 7 shows a schematic perspective view of the machine foundation after fixing of the machine bed;

FIG. 8 shows a schematic perspective view of an embodiment comprising a raised access platform;

FIG. 9 shows a schematic perspective view of an embodiment comprising a lowered arrangement of the machine foundation;

FIG. 10 is a schematic perspective view of a modular casting mold, and

FIG. 11 shows a flow diagram of a method for producing a mount for machine tools.

### DESCRIPTION OF THE PREFERRED EMBODIMENTS

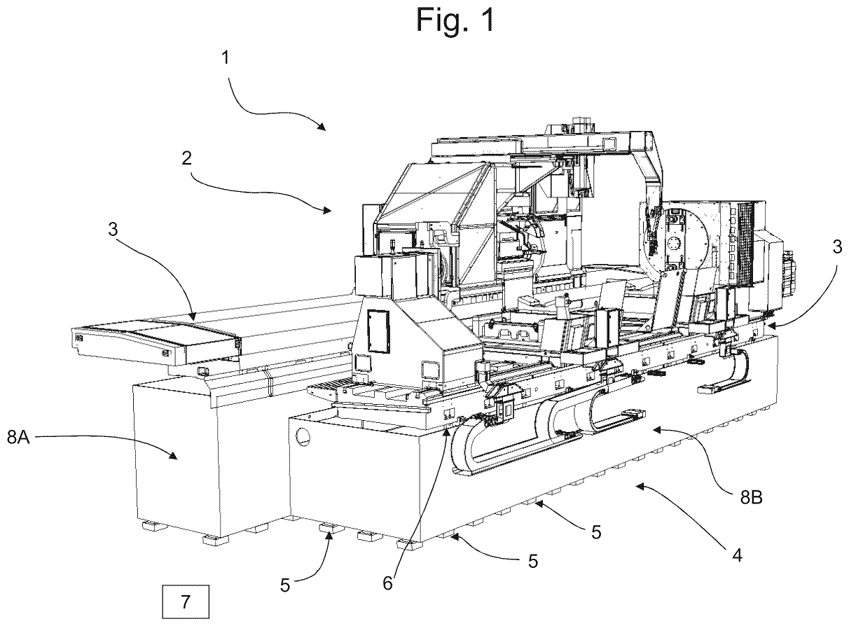

FIGS. 1 to 9 show an arrangement-designated in its entirety by the reference numeral 1—of a roll grinding machine 2 on a machine bed 3.

The roll grinding machine 2 is supported in a displaceable manner on the machine bed 3. The machine bed 3 is, in turn, supported on a machine foundation 4 standing on the installation floor 7 with interpositioning of adjustable fixators 6 at the installation site. The installation floor 7 is thus the floor at the location where the roll grinding machine 2 is used. The installation site is thus the location where the roll grinding machine 2 is used.

The machine foundation 4 is installed on a plurality arranged and oriented vibration-damping and height-adjustable supporting elements or supports 5 on the installation floor 7.

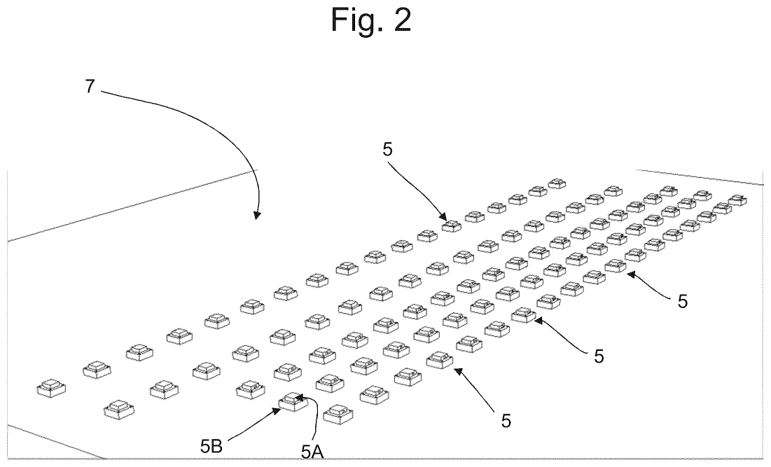

The supporting elements 5 each have height-adjustable wedge shoes 5A and rubber pads 5B there below. These are placed and oriented in such a manner that the necessary vibration-damping properties are achieved and a planar supporting surface is provided for an arrangement of a casting mold 8 (see FIG. 2).

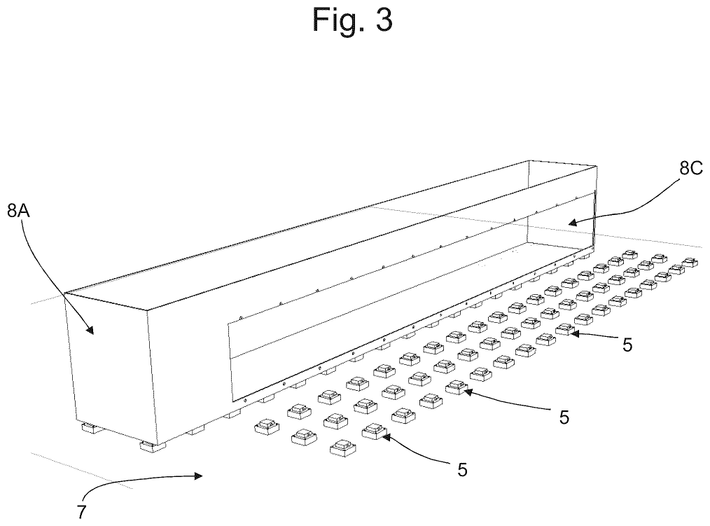

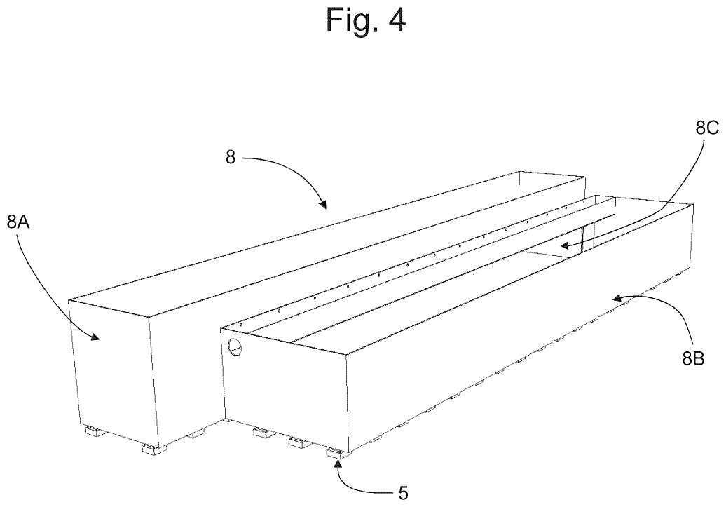

In the illustrated embodiment, the machine foundation 4 is cast in a casting mold 8 which is provided at the installation site on the installation floor 7. In the present case, the casting mold 8 consists of two part-casting molds 8A, B which are fixed to one another via a mutually facing window region 8C and are subsequently cast (see FIGS. 3 and 4).

In the illustrated embodiment, the casting mold 8 remains on the machine foundation 4 after the casting procedure (see FIG. 1). Alternatively, the side walls of the casting mold 8 could also be removed. Only the base of the casting mold 8 is always lost in principle because it cannot be removed after the casting procedure without laboriously moving the machine foundation 4.

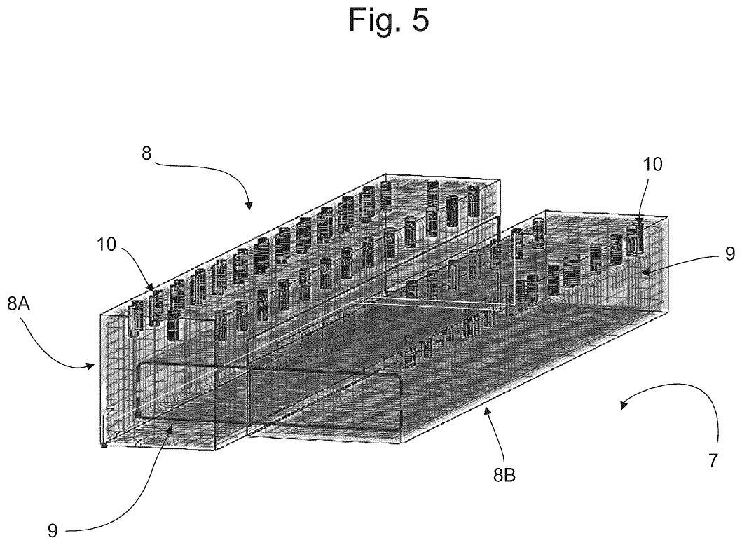

After the oriented installation and connection of the part-casting molds 8A, B, a steel mesh reinforcement 9 with place holder pots 10 placed thereon for subsequent fixator mounting is introduced into the casting mold 8 and is fixedly oriented (see FIG. 5).

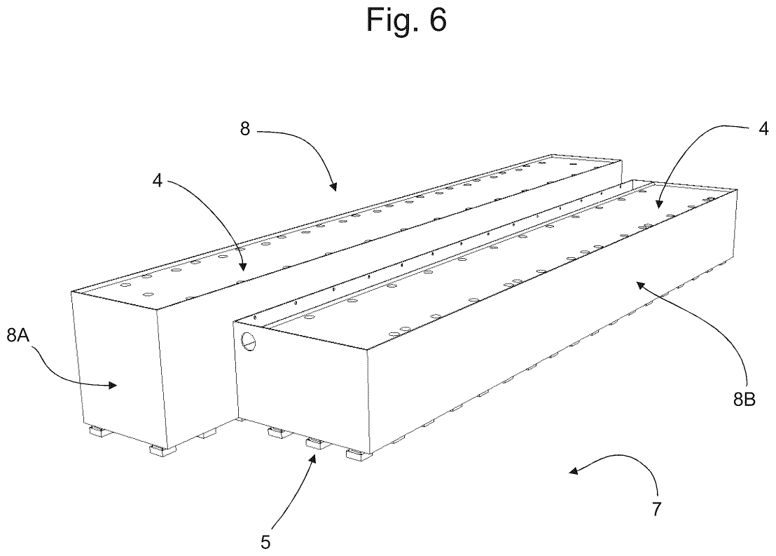

The casting mold 8 is then cast with class C40 concrete, wherein the place holder pots 10 naturally remain empty, thus allowing the fixators 6 to be subsequently mortared-in, having been oriented (see FIG. 6).

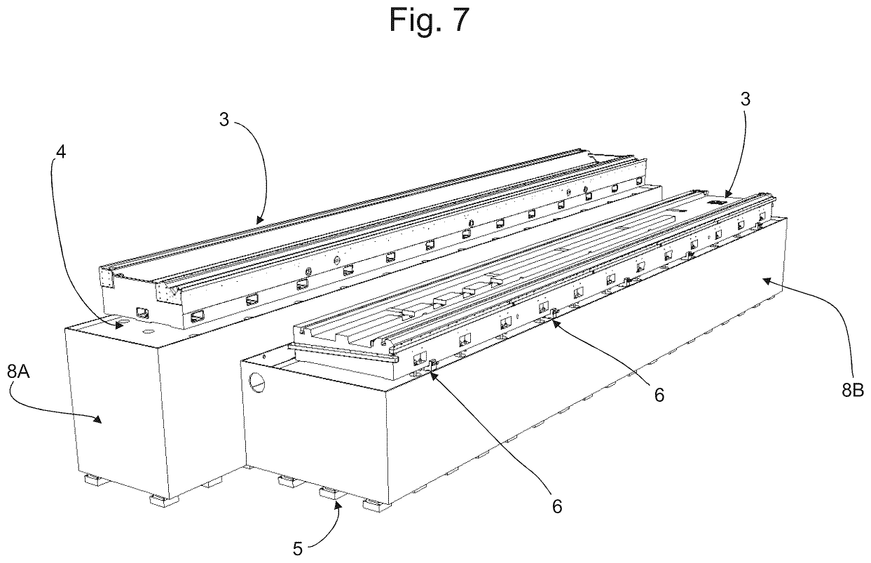

After hardening and fixator mounting, the fixators 6 are adjusted based on the measuring system and the machine bed 3 is fastened thereto (see FIG. 7). The fixators 6 are adjustable anchors to which the machine bed 3 is fastened and allow for a precise adjustment for exact positioning and levelling and may be adjusted both vertically and horizontally. For example, the adjustable anchor fixators may be provided with horizontally and vertically oriented threaded shafts for adjusting in the horizontal and vertical directions. One such form of fixators 6 may be BW-FIXATORS® provided by Fixatorenbau Bertuch & Co. GmbH of Germany.

The machine tool 2 is then actually arranged and fastened onto the machine bed 3 (see FIG. 1).

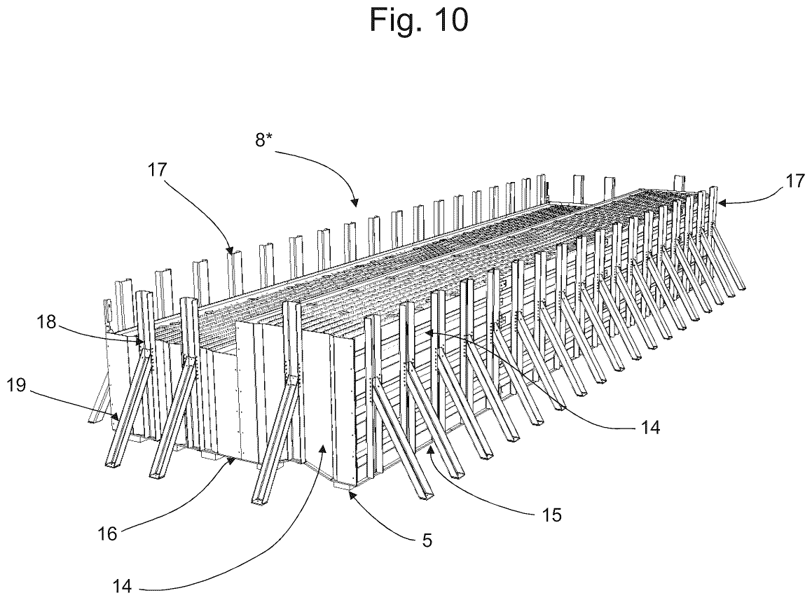

In an alternative embodiment, as is apparent from FIG. 10, the casting mold 8* can also be designed using a construction kit 13 which comprises a plurality of side wall panels 14, which can be fixed to one another temporarily for the casting procedure, and at least one lost base element 15 which can be connected to the side wall panels 14, and which are assembled at the installation site to form the casting mold 8*.

The base element 15 likewise consists of several mutually connectable part-elements 16.

The casting mold 8 and part-casting molds 8A, B are thus designed as a construction kit 13 which comprises a plurality of side wall panels 14, which can be fixed to one another temporarily for the casting procedure, and at least one lost base element 15, which can be connected to the side wall panels 14, or likewise part-elements 16 which are assembled at the installation site. For reinforcement, the side wall panels 14 and part-elements 16 are configured with ribs, beads, corrugations, Z-shaped cross-sections or formed as sheet pile walls, etc.

The side wall panels 14 designed as sheet metal elements for producing the side walls of the casting mold are arranged next to one another on the base element 15 which, in turn, has been previously assembled from the part-elements 16, and are fastened to one another and to the base element 15 or part-elements 16. This is effected in the present case by means of plug-in connections. The side wall panels 14 can be plug-connected to one another using a tongue and groove principle and can be inserted into corresponding slots in the base element 15 via plug-in lugs.

The side wall panels 14 are held via removable supports 17 during the casting procedure. The supports 17 can be placed against each side wall panel 14 or can be temporarily fixed to existing fastening points (fastening slots as indicated above) at that location. The supports each have a vertical element 18, which has a U-shaped cross-section, for abutment against the side wall panel 14 and an oblique element 19 for introducing the supporting force, which is connected to the vertical element 18 by bolting.

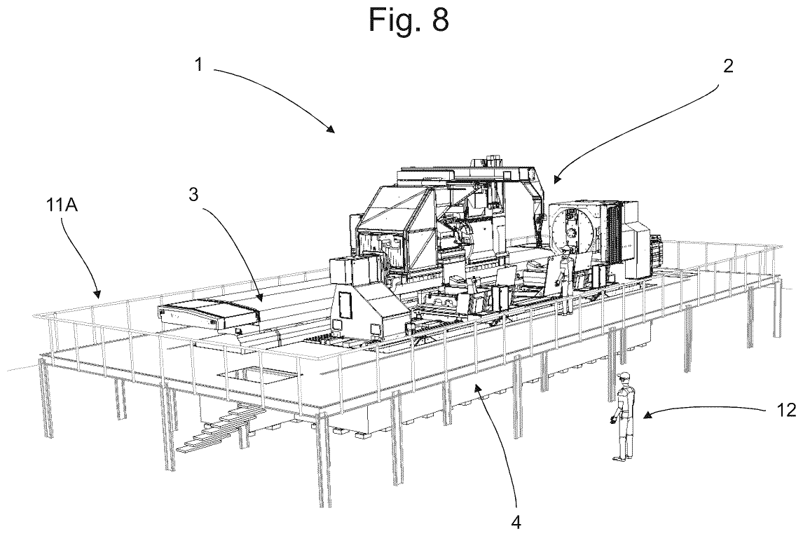

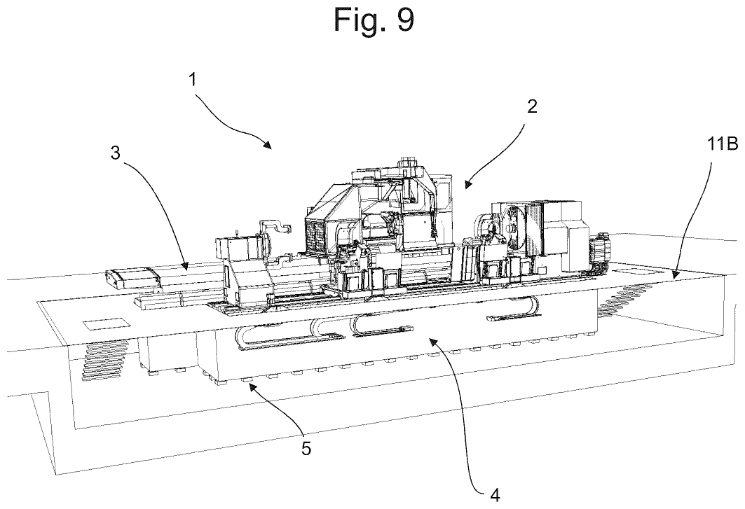

As shown in FIGS. 8 and 9, the installation site on the installation floor 7 can, on the one hand, be at ground level (e.g. on a workshop floor), so that a raised access platform 11A, which can be accessed via steps, allows the personnel 12 to access the machine tool 2, or, on the other hand, it can be sunk in the manner of a trough, so that access at ground level is permitted via an access platform 11B which covers the trough.

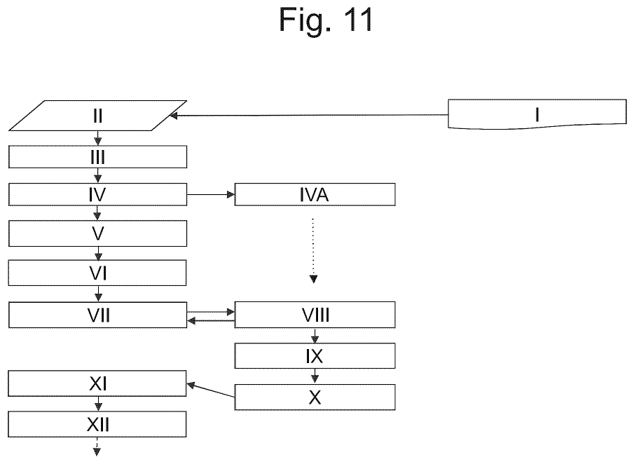

The method for producing a mount for machine tools, wherein the machine foundation is cast at the installation site on the installation floor in a casting mold provided at the installation site, is depicted once again in the flow diagram of FIG. 11.

After an order I for the machine tool has been placed and then the machine specifications and installation site II are known accordingly, the machine foundation can initially be designed and calculated III.

Then, in step IV the reinforcement is designed and calculated. This can then be produced externally or locally in the vicinity of the installation site in parallel with the further method in step IVA so that it is available at the correct time for placement into the casting mold.

In step V, the casting mold parts are then produced or reused-depending on what is possible or necessary.

After transporting the casting mold parts to the installation site in step VI, the actual casting mold is assembled by placing and orienting the supporting elements on the installation floor at the installation site and subsequently assembling the casting mold parts in step VII. The supports are then likewise attached.

The reinforcement, together with the place holder pots, is then inserted in step VIII and the concrete is cast in step IX and subsequently hardened in step X.

The finished foundation is then released from the supports and lateral casting mold parts in step XI.

Then, in step XII, the fixators are mounted and oriented and the machine bed is attached and finally the machine tool is assembled thereon.

Finally, technical approval can take place and the dismantled casting mold parts and supports can be reused.

Changes and modifications in the specifically described embodiments can be carried out without departing from the principles of the present invention which is intended to be limited only by the scope of the appended claims, as interpreted according to the principles of patent law including the doctrine of equivalents.

1. A method for producing a mount for machine tools, said method comprising:
providing a casting mold at an installation site;
casting a machine foundation in the casting mold on an installation floor at the installation site;
supporting a machine bed on the machine foundation, wherein supporting the machine bed comprises interpositioning adjustable fixators between the machine bed and the machine foundation;
wherein the machine bed is configured to support a machine tool in a displaceable manner on the machine bed.

2. The method of claim 1, wherein the machine tool comprises a roll grinding machine.

3. The method as claimed in claim 1, further comprising placing the casting mold on a plurality of arranged and oriented vibration-damping and height-adjustable supports.

4. The method as claimed in claim 3, wherein the casting mold is modular and/or consists of a plurality of part-casting molds which are fixed to one another prior to said casting the machine foundation in the casting mold.

5. The method as claimed in claim 4, wherein the casting mold and part-casting molds are designed as a construction kit which comprises a plurality of side wall panels that can be fixed to one another temporarily for the casting procedure, and at least one lost base element that can be connected to the side wall panels and are assembled at the installation site to form the casting mold or the part-casting molds.

6. The method as claimed in claim 5, wherein the base element comprises a plurality of mutually connectable part-elements.

7. The method as claimed in claim 5, wherein the side wall panels are held via supports during said casting the machine foundation in the casting mold.

8. The method as claimed in claim 4, wherein prior to said casting the machine foundation in the casting mold, at least one reinforcement and/or a plurality of place holders for the adjustable fixators and/or ductwork for subsequent lines and/or media are positioned in the casting mold.

9. The method as claimed in claim 8, wherein after the casting has hardened the fixators are fixed into gaps that are produced by the place holders with grouting mortar after exact positioning.

10. The method as claimed in claim 4, wherein class C40 or 45 concrete is used for casting the machine foundation.

11. The method as claimed in claim 1, wherein the casting mold is modular and/or consists of a plurality of part-casting molds, and wherein said method further comprises fixing the modular casting mold and/or the plurality of part-casting molds together prior to said casting the machine foundation in the casting mold.

12. The method as claimed in claim 1, wherein the casting mold comprises a plurality of side wall panels and at least one lost base element, and wherein said method further comprises assembling the casting mold at the installation site by fixing the side wall panels to one another and to the at least one lost base element.

13. The method as claimed in claim 12, wherein the base element comprises a plurality of mutually connectable part-elements.

14. The method as claimed in claim 12 wherein the side wall panels are held via supports during said casting the machine foundation in the casting mold.

15. The method as claimed in claim 1, wherein prior to said casting the machine foundation in the casting mold said method further comprises positioning in the casting mold at least one of (i) reinforcements, (ii) a plurality of place holders for the adjustable fixators, and (iii) ductwork for subsequent lines and/or media.

16. The method as claimed in claim 1, further comprising exact positioning of the fixators and fixing the fixators with grouting mortar into gaps formed by place holders in the casting after the casting has hardened.

17. The method as claimed in claim 1, wherein concrete is used for casting the machine foundation.

18. A mounting system for mounting machine tools, comprising:
a machine tool that is displaceably supported on a machine bed, and the machine bed is in turn supported on a machine foundation with adjustable fixators intorpositioned between the machine foundation and the machine bed;
wherein the machine foundation is located at an installation floor of an installation site and the machine foundation is produced at the installation site on the installation floor according to the method of claim 1.

19. The mounting system of claim 18, wherein the machine tool comprises a roll grinding machine.

20. The mounting system of claim 18, wherein the machine foundation is disposed on a plurality of arranged and oriented vibration-damping and height-adjustable supports.
